(19) United States
(12) Patent Application Publication
(10) Pub. No.: US 2004/0105914 A1
(43) Pub. Date: Jun. 3, 2004

(54) Health foods containing natto kinase and fermented milk products

(76) Inventors: Koichiro Tokumaru, Kanagawa (JP); Sennosuke Tokumaru, Kanagawa (JP)

Correspondence Address: Peter F Corless, Edward & Angell, PO Box 9169, Boston, MA, 02209, US

(21) Appl. No.: 10/472,843

(22) PCT Filed: Mar. 22, 2002
(86) PCT No.: PCT/JP02/02753

(30) Foreign Application Priority Data
Mar. 22, 2001 (JP) 2001-82366

(51) Int. Cl. A23C 9/12

(52) U.S. Cl. 426/34

(57) ABSTRACT

Food compositions whereby natto kinase, which is a component of natto, can be easily taken; and food compositions comprising a combination of a Japanese food material natto with a western food material fermented milk product, for each of which some people have a dislike, so as to achieve the hygienic advantages of both of these materials and expect specific hygienic effects. Namely, food compositions comprising a freeze-dried fermented milk product, natto kinase and carriers usable in foods; and functional foods containing these components which have effects of preventing thrombosis, improving blood fluidity, preventing platelet aggregation and ameliorating lipid metabolism. These food compositions enable not only to easily take the components of the fermented milk product and natto without showing the characteristic smell of natto but also to achieve hygienic effects including amelioration in intestinal disorders, immnopotentiation and antitumor activity caused by the fermented milk product as well as the prevention and treatment of thrombosis owing to the synergistic effect thereof with natto kinase.

### TECHNICAL FIELD

The present invention relates to a health food derived from natto (Japanese fermented soybeans) which has been entered into the eating habits of the Japanese people from a long time ago. It particularly relates to a food composition containing fermented milk which has been receiving public attentions for its hygienic effect and natto kinase derived from natto which has been entered into eating habits of the Japanese people from a long time ago and, more particularly, it relates to a functional food having anti-thrombotic action, blood fluidity improving action, platelet aggregation suppressing action and lipid metabolism ameliorating action and being expected to have an excellent effect for treatment and prevention of thrombosis.

### BACKGROUND OF THE INVENTION

Due to increase in concern about health in recent years, in addition to the primary function being inherent in food as nutrient for maintaining the life and the secondary function as taste, there have been also carried out various studies for function of physical condition adjustability such as biorhythm adjustment, bioprophylaxis, prevention and recovery of diseases and prevention of aging which are the tertiary function. Separately from drugs aiming a symptomatic treatment, it has been widely receiving public attention to take a health food or a functional food where the tertiary function is enhanced so as to maintain the good health more positively, because of an increase in concern about health, and also an expectation of suppression of an increase in medical expenses. Particularly due to diversification in the life style, and changes in eating habits, etc., further studies from various fields have been needed concerning preventive effects on life-style related diseases and various chronic diseases of those health food and functional food.

A functional food is the food which is generally manufactured by new technique using conventional foods as materials and components, able to be taken usually, and given more specific hygienic effect than a health food. As one of the examples thereof, the food using a sweetener which hardly causes decayed tooth has been available in the market. Many of them have been developed and manufactured from usually taken or traditionally used foods, not from materials which are specially prepared.

Under such circumstances, a health food or a functional food has wide needs and has been demanded to exhibit more specific efficacy.

For example, for a functional food, there is a tendency of demanding an effect of improving the fluidity of blood which is usually said as “an effect of making blood light and smooth”. A Factor for governing the fluidity of blood is related to a problem of blood vessel system and a function of blood components. When inner diameter of blood vessel becomes small due to arteriosclerosis, bloodstream becomes bad. When a lipid level in blood increases, viscosity of blood rises and further an aggregating ability of platelet increases. Upon the formation of intravascular thrombus, thrombolytic ability lowers, whereby bloodstream becomes bad. In blood corpuscle, when erythrocytes having bigger diameter than capillary pass through the capillary, they make their form flexible, give oxygen to vascular endothelial cells, receive CO₂ and circulate to lung via vein. Flexibility of erythrocytes as such is called deformation ability of erythrocytes and such a function becomes bad by life-style related disease, chronic disease or stress, etc. whereby microcirculation function lowers.

A specific example of the food is natto which is a food being widely used in Japan from a long time ago and is a fermented food by Bacillus subtilis natto which is classified as one of B. subtilis. This has been introduced into Europe and America as the traditional health food of Japan in the name of “vegetable cheese”. Recently, it has been reported that natto contains an enzyme called natto kinase. It has been known that natto kinase can be easily purified from natto by combining the operations of extraction, salting-out, chromatography, gel filtration, etc. Natto is white crystalline powder, having a natto-like smell, being colorless and transparent in a form of aqueous solution, and being stable by heating up to 60° C. in a basic aqueous solution of pH 6 to 12. Its amino acid sequence has been also elucidated and known to be a polypeptide of a single-stranded structure consisting of 275 amino acid residues having no S—S bond at all. Its molecular weight by means of gel filtration is 20,000±5,000.

With regard to its durability, natto kinase has acting time of 4˜12 hours, which is long as compared with urokinase.

The natto kinase contained in natto provides the taste which is specific to natto and, in addition, it is an enzyme of a serine protease system which is the same as urokinase of a thrombolytic enzyme, and tissue plasminogen activator (TPA), etc. It has been confirmed that natto kinase itself has a strong thrombolytic ability and also has an indirect effect of increasing the amount of TPA in blood.

As described above, there have been several reports for favorable action of natto kinase in terms of health. However, natto kinase has a specific smell of natto, therefore, using natto kinase as a food by being directly contained with food provides many problems in view of the taste.

The consumption of fermented animal milk products, such as yogurt and cheese, has been increased as a result of an increase in the hygienic effect of them. Various foods including confectionery based on fermented animal milk products have been developed. Particularly, it has been reported that in the race taking a lot of fermented animal milk products many people live long and incidence rate of cancer etc. is low; therefore, fermented animal milk products have been receiving public attention as health foods. It has been further noted in recent years that the products have a hypotensive action.

However, they are foods which are essentially hard to be preferred by Japanese people, particularly aged ones, having an eating habit based on rice.

### DISCLOSURE OF THE INVENTION

The present invention provides a food composition in which fermented milk product and natto, each of which receives public attention for its hygienic effect but, still, there are people who dislike it, are combined, and any person, both old and young, in any area is able to easily take and enjoy their hygienic effects.

The present invention also provides a food composition where natto kinase can be easily taken by improving the smell and taste which are specific to natto kinase.

The present inventors have investigated health foods having both meritorious advantage of natto and that of fermented animal milk product and unexpectedly found that a food composition containing both natto which is a Japanese food material and fermented animal milk product which are western food material is able to improve the specific smell and taste of natto kinase and also able to be a food which can fully utilize the meritorious advantages of both.

Thus, the present invention relates to a food composition containing a freeze-dried fermented milk product, natto kinase, and carriers usable in foods. The present invention also relates to a food composition comprised by further adding complementary components such as phosphatidylserine and processed ginseng to a freeze-dried fermented milk product and natto kinase. The present invention further relates to a functional food containing these components which have effects of preventing thrombosis, improving blood fluidity, preventing platelet aggregation, and ameliorating lipid metabolism.

### BRIEF DESCRIPTION OF THE DRAWINGS

FIG. 1 is a drawing which shows the result of Test Example 2. It shows an effect of improvement in blood fluidity when kefir natto kinase tablets are administered once.

FIG. 2 is a drawing which shows the result of Test Example 2. It shows an effect of improvement in blood fluidity when kefir natto kinase tablets are administered once.

FIG. 3 is a drawing which shows the result of Test Example 2. It shows an effect of improvement in blood fluidity when kefir natto kinase tablets are administered for seven days.

FIG. 4 is a drawing which shows the result of Test Example 2. It shows an effect of improvement in blood fluidity by kefir natto kinase tablets.

FIG. 5 is a drawing which shows the result of Test Example 2. It shows an effect of improvement in blood fluidity in N-5 and N-6 among the persons tested.

### BEST MODE FOR CARRYING OUT THE INVENTION

The freeze-dried fermented milk product in the food composition of the present invention is freeze-dried products such as kefir, yogurt, koumiss, lassie, etc. produced by fermentation of animal milk, i.e. milk of cow, horse, sheep, goat, etc. and is able to be prepared by a method which has been known in the field concerned. Preferably, it is a freeze-dried product of kefir which is a product obtained by addition and fermentation of kefir grains to cow's milk (hereinafter, referred to as kefir). With regard to a method for manufacturing the same, JP-A-62-83842, for example, may be referred to and its shape is white to pale yellowish white powder.

Further, natto kinase of the present invention will be illustrated. Natto kinase is easily manufactured from natto which is a fermented soybean product in Japan from a long time ago by means of a combination of operations such as extraction, salting-out, chromatography, gel filtration, etc. and is commercially available as well. It is white crystalline powder, has a natto-like smell, colorless and transparent in a form of an aqueous solution and stable in a basic aqueous solution of pH 6 to 12 by heating up to 60° C. It is a serine enzyme which is same as urokinase of a thrombolytic enzyme and tissue plasminogen activator (TPA), etc. Its amino acid sequence has also been elucidated and characterized as a polypeptide of a single-stranded structure comprising 275 residues having no S—S bond at all. Its molecular weight by gel filtration is 20,000±5,000 and its average activity is about 40 CU (plasmin unit)/g. Its strong thrombolytic ability and its indirect effect of increasing the TPA amount in blood have been confirmed as well. Natto kinase is less expensive and, in addition, the duration of action is long. Recently, its efficacy to infectious diseases such as O-157 has been receiving public attention.

With regard to the natto kinase of the present invention, commercially available natto kinase may be used and it is not always necessary to use a fully-purified natto kinase. There is no particular limitation therefor so far as it contains natto kinase and is able to be used as food. For example, anything which contains natto kinase such as a natto extract or a processed product thereof may be used as the natto kinase of the present invention.

With regard to the carrier in the food composition of the present invention, there is no particular limitation so far as it does not adversely affect on the taste of the food composition of the present invention but favorably affects on the hygienic meritorious advantage of natto kinase and fermented milk product.

Complementary components in the food composition of the present invention are food materials used as food or extracts thereof and there is no particular limitation therefor so far as they do not adversely affect on the taste of the health food of the present invention but favorably affect on the hygienic meritorious advantage of natto kinase and fermented milk product. Examples of the preferred complementary components are phospholipid such as phosphatidylserine and ginseng.

Phosphatidylserine (PS) is a kind of phospholipid, said to be able to enhance the cerebral function such as learning ability, memory, thinking power and recognizing power against failure of memory due to Alzheimer's disease in early stage and to aging and expected to have an effect of improving Parkinson's disease and nervous depression. Thus, PS is believed to have actions of promoting the intake of nutrition into cells, activating the information transmittance among nerve cells and promoting the production of neurotransmitter and is expected to have an effect for the treatment of dementia of an Alzheimer type.

Ginseng has been known as a component for health foods and Chinese galenical medicines from a long time ago and has been known to have actions such as hypoglycemic action, improvement in adrenocortical function, improvement in myocardial function, and improvement in metabolism, improvement in cholesterol, etc. With regard to ginseng, processed ginseng products such as extract, dried product, and diluted powder thereof can be also used.

Further, with regard to other preferred complementary components in the food composition of the present invention includes food materials used as food and extracts thereof such as various kinds of vitamins, calcium preparations, lactic acid bacteria, oligosaccharide, dietary fiber, plum extract containing mumefural, and black vinegar.

Oligosaccharide is a substance where 2 to 10 monosaccharides such as glucose, fructose or galactose are subjected to a glycoside bonding, which has been already available in the market and is a proliferation factor acting as a nutrient for lactic acid bacteria such as Lactobacillus bifidus and L. lactis, and Streptococcus faecalis which are intestinal useful bacteria. Therefore, intestinal useful bacteria are proliferated forming a preferable intestinal environment where useful bacteria are dominant.

Dietary fiber is fiber which is contained in large quantities in plant foods such as okara (bean-curd leavings), dried shiitake mushroom, dried hijiki (a kind of brown algae), cloud ear mushroom, laver and soybean. These components had been despised as indigestible component disturbing digestion and absorption of nutrients and not acting as an energy source; however, recently, it has been receiving public attention in view of its effects of improvement of intestinal disorders and consumption.

Sporogenous lactic acid bacteria have a high stability and excellent ability for the production of lactic acid bacteria and, therefore, they surely arrive intestinal tract and an active action for improving the intestinal disorders can be expected. Calcium preparation has an action of enhancement of calcium and multivitamin preparation has an action of enhancement of specific vitamins.

Plum extract containing mumefural has been noted to exhibit pharmaceutical effects from a long time ago and known to have actions such as recovery from fatigue, antibacterial, anti-inflammation, activation of digestive organs. Components contained therein are diverse such as minerals, catechins, amino acids. Recently, it has been found that mumefural produced by heating the contained components during the stage for the manufacture of plum extract particularly from raw plum has an action of disturbing the aggregation of platelets, and an effect of improvement in bloodstream by its synergistic effect with other components contained in the plum extract has been receiving public attention.

Black vinegar is a kind of vinegar manufactured from rice and has been known to have actions such as improvement of cholesterol and neutral fat (improving action for lipid metabolism), improvement of bloodstream (improving action for erythrocyte deforming ability), anti-allergic action, hypotensive action, hypoglycemic action, liver activating action, antioxidant action. It is, however, preferred to previously make into microcapsules or the like in compounding with a food composition, whereby the hygienic effect of natto kinase can be fully achieved. With regard to the black vinegar, the preferred one is black vinegar where mold rice, steamed rice and underground water are materials and three fermentations of saccharification, alcoholic fermentation and acetic fermentation, naturally proceeded.

In addition, the following materials or extracts thereof which are used as food may also be exemplified as complementary components in the food composition of the present invention. They includes onion extract having an action of activating the dissolution of cellulose and a hypolipemic action; green pepper and peanut having a bloodstream improving action; ginkgo leaves and tomato having a bloodstream improving action; CoQ 10 (coenzyme Q 10) having an antioxidant action and a cardiac disease preventing action; astaxanthin having an antioxidant action; tocotrienol having an antioxidant action and an arteriosclerosis improving action; St.-John's-wort having an anti-anxiety action whereby prevention of cardiac diseases can be expected; extract of pine bark having an antioxidant action; GABA (γ-aminobutyric acid) having a suppressive action to hypertension; etc.

The amount of the freeze-dried fermented milk product used in the food composition of the present invention is 10 to 40% by weight, preferably 10 to 35% by weight or, more preferably, 20 to 30% by weight to the total weight of the health food. With regard to the natto kinase of the present invention, the weight of commercially available natto kinase is 5 to 25% by weight, preferably 5 to 20% by weight or, more preferably, 10 to 15% by weight to the total weight of the food composition.

Amounts of the freeze-dried fermented milk product and natto kinase in the food composition of the present invention in terms of their ratio by weight are 1:0.1 to 2, preferably 1:0.3 to 1 or, more preferably, about 1:0.3 to 0.8.

Although there is no particular limitation of the amount of the above-mentioned complementary components used, it is 0.1 to 35% by weight, preferably 0.2 to 25% by weight or, more preferably, 0.2 to 20% by weight to the total weight of the food composition. It is also necessary that the amount of the complementary component used is adjusted depending upon the adding component.

Besides the above-mentioned components, the food composition of the present invention can be added extender, thickener, taste-adjusting agent, lubricant, disintegrating agent, etc., which are used as food. If necessary, it is also possible to color the composition using pigment.

These adding components include maltitol, crystalline cellulose, thickening polysaccharide, potato starch and rice bran wax.

The food composition of the present invention may be manufactured by mixing the above-mentioned components. With regard to the mixing, those components may be mixed at a time or a mixture prepared by mixing of some of the components may be mixed with other components.

The shape of the food composition of the present invention and the foods, prepared by using the same, may be powdery, but preferably it is in tablets or granules for making the ingestion easier. More preferably, it is in coated tablets. Smell of natto can be prevented more effectively by the coating layer. Tablets may be in any shape and any size so far as they do not inhibit the ingestion and, for example, they may be in a form of small egg or hand drum.

With regard to a coating agent, already-known materials such as cell wall of yeast, gelatin, glycerin, starch and cellulose may be appropriately used and, preferably, it is cell wall of yeast.

In addition to the main components, the food composition of the present invention may, if necessary, appropriately select components from a group consisting of complementary components such as multi-vitamin preparation, sporogenous lactic acid bacteria, calcium preparation, oligosaccharide, dietary fiber and phosphatidylserine, components for making into tablets such as extender and coating agent. Because of comprising an activating action for cerebral cells, it is preferred that at least phosphatidylserine (abbreviated as PS) is added.

The example of components and compositions in one particle of the food composition of the present invention is shown in the following Table 1.

TABLE 1
Components and Compositions (per particle)

| | Weight | |
|---|---|---|
| Material Names | (%) | Remarks |
| Freeze-dried kefir | 25 to 35 | main component |
| Natto kinase | 10 to 15 | main component |
| Multi-vitamin preparation | 2 to 4 | complementary component |
| Sporogenous lactic acid | 0.2 to 0.8 | complementary component; |
| bacteria | | agent for intestinal disorders |
| Calcium preparation | 3 to 6 | complementary component |
| | | such as milk calcium |
| Maltitol | 25 to 35 | material for making into tablets |
| Crystalline cellulose | 3 to 6 | material for making into tablets |
| Thickening polysaccharide | 0.2 to 0.8 | material for making into tablets |
| Potato starch | 2 to 6 | material for making into tablets |
| Rice bran wax | 2 to 6 | releasing agent from tabletting |
| Coating agent comprising | 3 to 8 | mold coating agent |
| cell wall of yeast | | |

In the preferable embodiment of the food composition of the present invention, freeze-dried kefir and natto kinase are main components, phospholipid such as phosphatidylserine and ginseng as well as multi-vitamin preparation, sporogenous lactic acid bacteria, calcium preparation, oligosaccharide, dietary fiber and mumefural-containing plum extract are used as complementary components, materials for making into tablets, such as extender for making tablets formation easier and thickeners for giving appropriate viscosity, are used, and it is coated with a coating agent.

As mentioned above, the food composition of the present invention contains freeze-dried fermented milk products such as freeze-dried kefir and natto kinase as main components and, therefore, it is able to achieve the following effects.

First, natto kinase is a thrombolytic enzyme which is produced by Bacillus subtilis natto and has a very strong fibrinolytic ability. Namely, since both fermented milk product and natto kinase have an antithrombotic action, there is a further effect of synergism. Accordingly, it is believed that the food composition of the present invention has a sufficient effect of treatment and prevention of thrombosis such as cardiac diseases (myocardial infarction, angina pectoris, etc.) and cerebrovascular diseases (cerebral infarction, cerebral thrombosis, etc.) which occupies 31% of the cause of death of Japanese people (statistic data by the Ministry of Health and Welfare of Japan, 1995). Half-life in blood of the conventionally used thrombolytic agents (urokinase, TPA) is as short as 4 to 20 minutes while that of natto kinase is as long as 4 to 12 hours. Accordingly, natto kinase is able to sustain its thrombolytic action for a long period. Further, since thrombosis is one of the causes for senile dementia, it is believed that natto kinase is also effective for the prevention of dementia of a thrombosis type. Furthermore, since natto kinase is an enzyme being found in natto which is a traditional and representative fermented food in Japan, there are excellent characteristics that it is able to be produced in large quantities, able to be provided at a very low cost as compared with other drugs, and fully guaranteed for the safety of natto which has been orally taken as foods from a long time ago.

On the other hand, with regard to hygienic effect of the fermented milk product, it has been known to have an effect for intestinal disorders from a long time ago and, in addition, from the view of prevention of infection mainly in digestive tracts and in relation to the cancer cell suppressing effect, its immunopotentiating action has been suggested. It has been also suggested that ingestion of a fermented milk product suppresses the generation of cancer, and reported their anti-tumor activity. Further, it has been noted that, by administering a fermented milk product, platelets, and fibrinogen increase while decomposed products of fibrin formed by decomposition of fibrin decrease to get near the normal data. Namely, a decrease in the decomposed products of fibrin means a further decrease in fibrin and, since thrombus is mainly composed of fibrin generated by blood coagulation, bloodstream becomes smooth, solving bloodstream disturbance, and anti-thrombosis action is enhanced whereupon hypotensive action can be expected as well.

In addition, since the food composition of the present invention is preferably made into tablets and their surface is coated, handling and ingestion thereof is easy; and also incompatibility to the smell of natto can be solved. Moreover, in the food composition of the present invention, it can be expected to obtain the specific effect of complementary components, which cannot be fulfilled by only the main components, by compounding of complementary components and by selecting the type thereof. Namely, since sporogenous lactic acid bacteria are highly stable and also have excellent ability of producing lactic acid bacteria, they surely arrive the intestinal tract and are believed to achieve the active action for improving the intestinal disorders. Calcium preparation has a calcium reinforcing action while multi-vitamin preparation has an action of enhancing specific vitamins.

As hereunder, the present invention will be illustrated in more detail by Examples; however, the present invention is not limited to those Examples.

### EXAMPLES

### Example 1

25.0 g of Kefir powder, 10.5 g of natto kinase and materials for the preparation of tablets were mixed and made into tablets to obtain uncoated very small tablets in a shape of hand drum. The resulting tablets had an average weight of 0.300 g. They were coated with a coating agent of yeast cell wall to obtain a health food of the present invention. The coated tablet was 0.310 g (in terms of average weight). The tablets were administered at the dose of three tablets a day.

### Example 2

20.0 g of Kefir powder, 10.5 g of natto kinase, 10 g of ginseng, 8 g of black vinegar, 5 g of ginkgo leaves, 5 g of phosphatidylserine and materials for the preparation of capsules were mixed to obtain capsules having an average weight of 0.300 g. The capsules were administered at the dose of three capsules a day.

### Example 3

28.0 g of Kefir powder, 10.5 g of natto kinase, 2.5 g of multi-vitamin preparation (powder), 0.2 g of sporogenous lactic acid bacteria, 4.8 g of calcium preparation (milk Ca), 28.5 g of maltitol (extender; material for the preparation of tablets) and 8.5 g of materials for the preparation of tablets were mixed to obtain a kneaded product. Followed by obtaining uncoated tablets in a form of hand drum from the kneaded product during a granulation step. The resulting tablets had an average weight of 0.350 g and were coated with a coating agent of yeast cell wall to obtain a health food of the present invention. The coated tablet was 0.371 g (in terms of average weight). The tablets were administered at the dose of three tablets a day.

### Test Example 1

The kefir-natto kinase tablets manufactured in Example 3 (hereinafter, may be abbreviated as KK) were administered for one week to 20 persons (8 males and 12 females) who disliked either natto or milk product, and the effect was examined.

<Result of the Examination>

1. Did you feel resistance to take them?

| | |
|---|---|
| yes | 0 (0%) |
| no | 19 (95%) |
| neither yes nor no | 1 (5%) |

2. Did you feel any improvement by taking them?

| | |
|---|---|
| Stomach became in good condition | 8 (40%) |
| Stiffness of shoulders got well | 3 (15%) |
| Good sleep was achieved | 2 (10%) |
| Hardly getting tired | 1 (5%) |
| No particular improvement | 5 (25%) |
| Stopped taking halfway | 1 (5%) |

From the above examination, it was noted that the food composition of the present invention can be easily taken even by people who dislike natto or milk products and hygienically preferable components contained in natto and milk products can be also easily taken.

Since the examination was carried out in a short period of one week, 25% of the persons replied that they did not feel any improvement. However, in spite of the short period of one week, the fact that 25% replied “stomach became in good condition”, 15% replied “stiffness of shoulders got well” and 10% replied “good sleep was achieved” shows excellent meritorious advantages of the food composition of the present invention.

### Test Example 2

With regard to the effect of improvement in bloodstream fluidity by administration of the kefir-natto kinase tablets prepared in Example 3, the effect was examined using Micro Channel Array Flow Analyzer (MC-FAN) where suppression of platelet aggregation, improvement in erythrocyte deformation ability and amount of lipid in blood were used as indexes.

1. Test Method

(1) Persons to be Tested

It is obvious from the preliminary test that the fluidity of blood of males is generally lower than that of females and, the fluidity tends to become lower with age. Therefore, in the present clinical test, significance of the test and safety of the test material were fully explained to the persons to be tested and eight volunteers (N-1 to 8) who were Japanese males at the age of their forties or more cooperated with the test.

(2) Ingestion of the Kefir-Natto Kinase Tablets

Since one week before the test, the persons to be tested were asked to refrain from taking food materials which are said to affect the fluidity of blood such as natto, green pepper, peanuts, onion and plum. For the breakfast on the day of the test, nothing except water was taken and, even after the blood drawing between 9 and 10 a.m. in the presence of a medical doctor, they were asked to refrain from eating and drinking except water.

Blood was drawn by the doctor and, after that, six kefir-natto kinase tablets of the present invention which were in a double amount of the usual dose were given to the persons together with hot water.

(3) Blood Drawing and Preparation of Heparinized Blood

7 to 8 mL Blood was drawn from the brachial veins of the persons to be tested and 1.9 mL thereof were placed in a test tube for the measurement made of polyethylene into which 0.1 mL of a heparin solution (1,000 units/mL) was previously placed to prepare a blood for the measurement of fluidity of whole blood. Residual blood (4 mL) was used for a blood test.

(4) Measurement of Fluidity of Blood

Fluidity of blood was measured according to a method of Kikuchi, et al. Namely, the time when 100 μl of whole blood was passed through a Microchannel Array (Bloody 6-7; manufactured by Hitachi Haramachi Denshi Kogyo) integrated in MC-FAN with a 20 cm water column difference was measured. The time for passing the blood was determined on the basis that the passing time of 100 μl of physiological saline measured just before the measurement was defined as 12 seconds and was calculated from the following formula.

[(Passing time of blood)×12 seconds]/[Passing time of physiological saline solution]

(5) Test on Fluidity of Blood

(i) Effect of one Ingestion

Fluidity of blood which was drawn before ingestion of the kefir-natto kinase tablets and 2 hours after the ingestion were compared and the effect of one ingestion was judged. At this time, heparin was used as a blood coagulation inhibitor. Heparin inhibits the activity of thrombin which converts fibrinogen of a coagulation factor in blood into fibrin. However, its effect to coagulation of platelets is said to be weak. Accordingly, the platelets contained in the collected blood will be in a state of being easily coagulated.

Thus, for the purpose of checking the influence of kefir-natto kinase tablets on fluidity of whole blood and coagulation of platelets, measurements were conducted immediately after drawing of blood (actually, three minutes thereafter) and 10 minutes thereafter (time when blood is in a state when platelets are apt to be coagulated).

(ii) Effect of Continuous Ingestion

The above test date was defined as the 0th day and the persons to be tested were asked to take six kefir-natto kinase tablets, which is a double dose of the usual dose, three times a day with hot water before each meal for one week from the 0th day and, after 7 days, fluidity of whole blood was measured again.

During the above period, the persons to be tested were asked to take meals as usual except the above-mentioned food materials, and also asked to make the life-style as ordinary as possible.

(iii) Blood Test

With regard to blood test, total cholesterol, HDL cholesterol, LDL cholesterol, neutral fat, free fatty acid, Ht value, erythrocyte numbers, platelet numbers and leukocyte numbers which are said to affect the fluidity of blood and the coagulation of platelets were measured on the initial day and the final day of the test.

II. Test Results

(1) Blood Properties of the Persons to be Tested and Evaluation for the Present Measuring Method

The method for measuring the fluidity of blood by the above technique is relatively simple and is excellent in terms of reproducibility as well. However, if any stimulation is applied during the blood drawing, the blood has a property of being quickly coagulated and such a reaction is a chain reaction as well. This is one of the biological defense systems of human being. If this reaction does not take place upon bleeding, it cannot be stopped bleeding and sometimes resulted to death.

In the present test, eight persons cooperated with test and, due to the failure during the blood drawing, coagulation was noted in two cases. All data relating to them were cancelled and efficacy of the kefir-natto kinase was judged by the data for six persons.

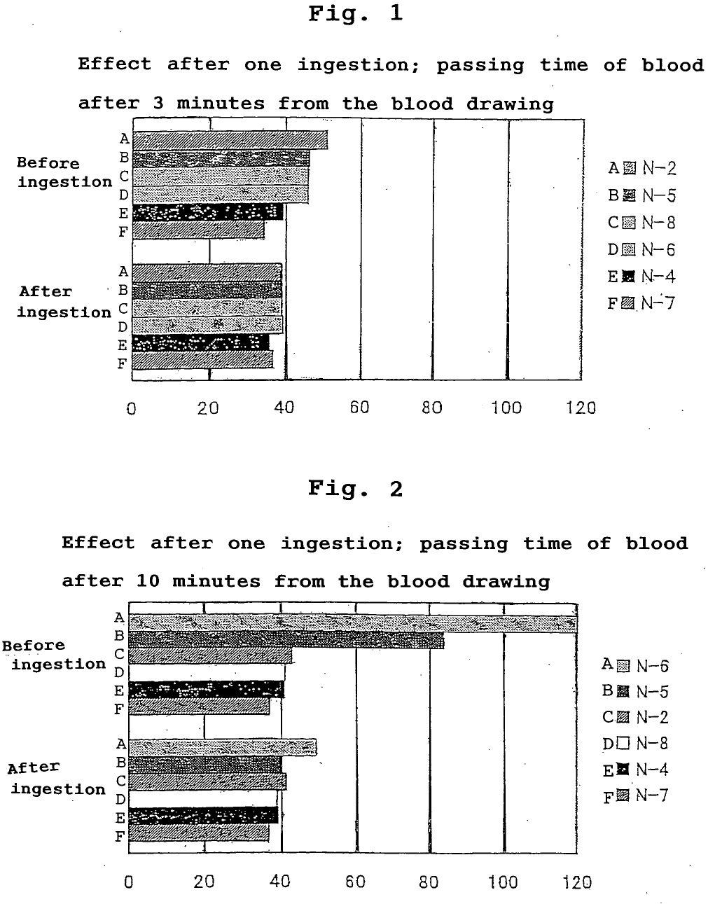

First, fluidity of whole blood before ingestion after 3 minutes from the blood drawing was shown in FIG. 1 as the time for passing of 100 μL of blood. It was 34.2 seconds for the quickest person while it was 60.4 seconds for the slowest person and, in view of the data in literatures, the data in those persons may be normal. However, when the same blood was measured again after 10 minutes from the blood drawing, time for passing of the whole blood in the blood, drawn from the persons N-5 and N-6 changed from 46.1 seconds to 84.1 seconds and from 45.8 seconds to 120.0 seconds, respectively whereupon coagulation of platelets was observed on the monitor. Namely, blood of the persons N-5 and N-6 are in a state where platelets are apt to be coagulated. By making the measuring time into a two-stage method, such a valuable information for the persons to be tested can be found.

(i) Effect of the One Ingestion of the Kefir-Natto Kinase Tablets

Immediately after measurement of above values, persons were asked to ingest the kefir-natto kinase tablets in a double amount of the normal dose and, two hours later, passing time of whole blood was measured again after 3 minutes and 10 minutes from the blood drawing.

In the measurement at 3 minutes after the blood drawing, passing time of whole blood was shortened in the five cases out of six. The result is shown in FIG. 1.

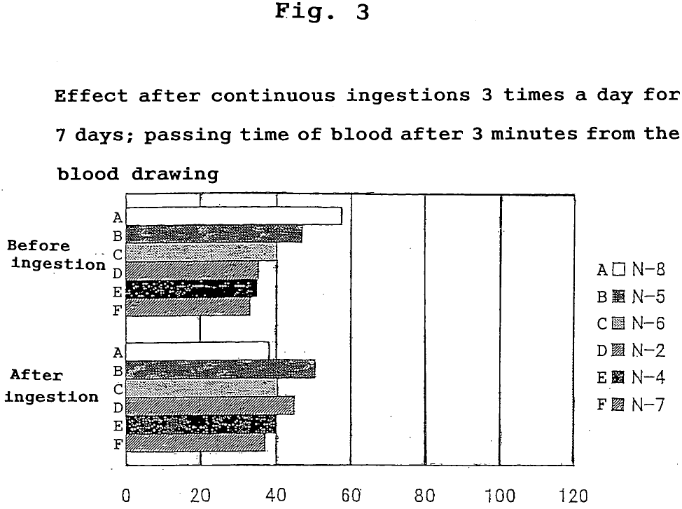

In the measurement after 10 minutes from the blood drawing, passing time of whole blood in the persons N-5 and N-6 where platelets were in a state of being apt to be coagulated was significantly shortened and coagulation of platelets was not observed on the monitor as well. The result is shown in FIG. 2.

From those results, it was noted that the kefir-natto kinase tablets have an effect of making blood light and smooth or, in other words, an effect of improving the fluidity of blood and that, as one of the action mechanisms therefor, an action of suppressing the platelet coagulation was suggested.

(ii) Effect of Continuous Ingestion of the Kefir-Natto Kinase Tablets

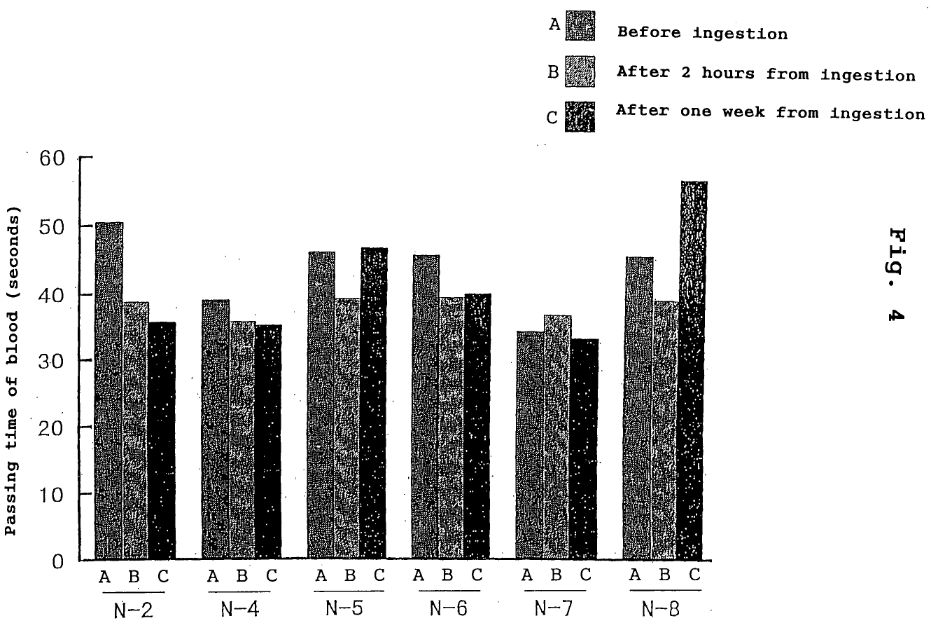

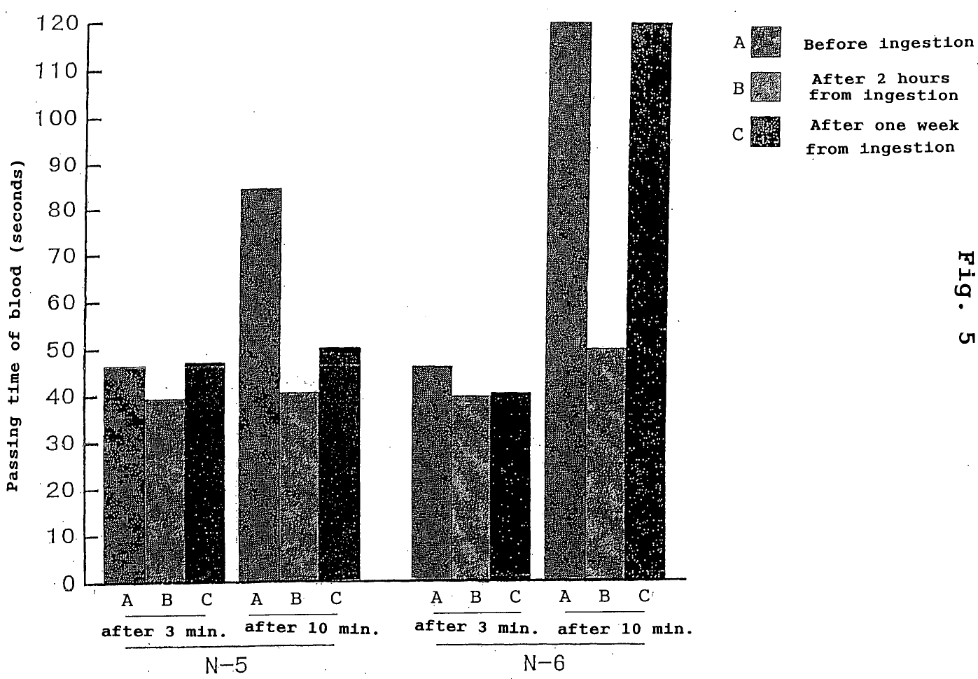

As mentioned above, the kefir-natto kinase tablets were given for seven days continuously and the passing time of the whole blood was measured again. As a result, the passing time of whole blood was shortened in four cases out of six, no change was noted in one case and extension was noted in one case (N-8). The result is shown in FIG. 3. Results of measurements before ingestion and 2 hours after the ingestion are shown in FIG. 4.

Before the test, the person to be tested (N-8) participated in preparation of the set, instruction and communication between medical doctors and persons to be tested, care for other persons to be tested, therefore, it is likely that they acted as stressors whereby the passing time of the whole blood became long.

Results of measurements before the ingestion, after 2 hours from the ingestion and after one week from the ingestion in the persons N-5 and N-6 where their platelets were in a state of being apt to be coagulated are shown in FIG. 5.

(iii) Blood Test

Serum component and blood corpuscle component affecting the fluidity and platelet coagulation of the whole blood were measured and the result is shown in the following Table 2. As a result of continuous ingestion for one week, there was a tendency that the amount of neutral fat lowered and the amount of free fatty acid increased. From the result, efficacy to abnormality in lipid metabolism can be expected.

TABLE 2
Data of Blood Test

| Tested Items | Before Ingestion | After Ingestion |
|---|---|---|
| Total cholesterol (mg/dl) | 211.1 ± 13.8 | 207.1 ± 11.4 |
| LDL cholesterol (mg/dl) | 121.2 ± 11.8 | 120.6 ± 8.5 |
| HDL cholesterol (mg/dl) | 60.1 ± 7.1 | 62.0 ± 7.4 |
| Neutral fat (mg/dl) | 151.0 ± 26.3 | 129.6 ± 20.0 |
| Free fatty acid (mEq/dl) | 0.467 ± 0.114 | 0.579 ± 0.118 |
| Numbers of erythrocytes (× 10⁴/μl) | 474.1 ± 11.6 | 474.3 ± 10.6 |
| Numbers of leukocytes (× 10⁴ μl) | 53.0 ± 4.4 | 58.7 ± 5.2 |
| Numbers of platelets (× 10⁴ μl) | 19.4 ± 2.1 | 21.9 ± 2.0 |
| Amount of hemoglobin (g/dl) | 14.5 ± 0.3 | 14.4 ± 0.3 |
| Hematocrit value (%) | 44.3 ± 0.8 | 43.9 ± 0.8 |
| MCV (fi) | 93.5 ± 1.5 | 93.4 ± 1.7 |
| MCH (pg) | 30.7 ± 0.7 | 30.6 ± 0.6 |
| MCHC (%) | 32.8 ± 0.4 | 32.8 ± 0.3 |

(2) Consideration in the Results

From the above results, the kefir-natto kinase tablets were suggested to have an effect of improving the fluidity of whole blood and an effect of suppressing the platelet coagulation. The fact that they shortened the passing time of whole blood in a state where platelets are apt to be coagulated is a particularly quite valuable effect.

It is believed that, in future, the effect to fibronolysis system where coagulated blood is positively and quickly dissolved is to be investigated.

### Industrial Applicability

As mentioned above, the food composition of the present invention is mainly comprising natto kinase derived from natto and freeze-dried fermented milk product such as freeze-dried kefir and is able to achieve the following effect.

First, natto kinase is a thrombolytic enzyme produced by Bacillus subtilis natto having a very strong fibrinolytic ability and has an anti-thrombus action together with fermented milk product whereby it is believed that there is a further effect of synergism and that there is a sufficient effect for treatment and prevention of thrombosis. Furthermore, natto kinase is believed to have an effect of prevention of dementia of a thrombosis type.

Moreover, since natto kinase is an enzyme found in natto which is a representative fermented food of Japan from a long time ago, it has excellent characteristics that a large-scale product is possible, that providing at a low cost as compared with other drugs is possible and that safety is well guaranteed because of oral ingestion of natto from a long time ago.

On the other hand, with regard to hygienic effect of fermented milk product, it has been already known to have an effect for intestinal disorders and, in view of prevention of infection mainly to digestive tracts and also in relation to the effect of suppression of cancer cells, there has been suggested an immunosuppressing action. Further, ingestion of fermented milk product has been suggested to suppress the generation of cancer and the anti-tumor activity thereof has been reported. Furthermore, it has been noted that administration of fermented milk product increases platelets and fibrinogen and that decomposed products of fibrin formed by decomposition of fibrin decreases coming near the normal value. Namely, a decrease in the decomposed products of fibrin means a further decrease in fibrin and, since thrombus is mainly composed of fibrin produced by coagulation of blood, bloodstream becomes smooth, disturbance of bloodstream is solved, anti-thrombosis action is enhanced, and hypotension action can be expected as well.

Still further, by containing other various complementary components, the food composition of the present invention can be used as a functional food where various hygienic effects such as not only anti-thrombosis action but also actions of improving the fluidity of blood, action of suppressing the coagulation of platelets, and action for improving the lipid metabolism can be expected.

1. A food composition comprising a freeze-dried fermented milk product, natto kinase and a carrier usable in foods.

2. The food composition according to claim 1, wherein a freeze-dried fermented milk product is a freeze-dried product of fermented milk product comprising cow's milk using kefir grains.

3. The food composition according to claim 1 or 2, wherein natto kinase is that which comprises an extract of natto or a processed product thereof.

4. A health composition according to any of claims 1 to 3, wherein a food composition further contains complementary component.

5. The food composition according to claim 4, wherein a complementary component is at least one kind of phosphatidylserine or a processed ginseng product.

6. The food composition according to any of claims 1 to 5, wherein it is a functional food having an anti-thrombosis action.

7. The food composition according to claims 1 to 5, wherein it is a functional food having an action of improving the fluidity of blood.

8. The food composition according to claims 1 to 5, wherein it is a functional food having an action of preventing the aggregation of platelets.

9. The food composition according to claims 1 to 5, wherein it is a functional food having an action of ameliorating the lipid metabolism.

10. The food composition according to any of claims 1 to 9, wherein a food composition is made into a form of tablets.

11. The health food according to claim 10, wherein the food composition made into a form of tablets is in a form of coated tablets.
